(19) United States
(12) Patent Application Publication
(10) Pub. No.: US 2011/0100156 A1
(43) Pub. Date: May 5, 2011

(54) STRESS-REDUCING TYPE ROTOR

(75) Inventors: Se Yong Jung, Daejeon (KR); Young Hee Han, Daejeon (KR); Byung Jun Park, Daejeon (KR); Sang Chul Han, Daejeon (KR); Byeong Cheol Park, Daejeon (KR); Jeong Phil Lee, Daejeon (KR)

(73) Assignee: Korea Electric Power Corporation, Seoul (KR)

(21) Appl. No.: 12/725,145

(22) Filed: Mar. 16, 2010

(30) Foreign Application Priority Data
Oct. 30, 2009 (KR) 10-2009-104039

(51) Int. Cl. F16F 15/315

(52) U.S. Cl. 74/572.21

(57) ABSTRACT

A rotor reducing stress concentration generated by centrifugal force, the rotor having interference fit between a reinforcing ring and the external circumference of a rotor cylinder or rotor cylinder having a hole, wherein the rotor preliminarily rotates at high speed so that the rotor is plastic-deformed in advance, so that less plastic-deformation occurs even when the rotor rotates at high speed compared to the case where plastic deformation is not performed in advance.

### CROSS-REFERENCE TO RELATED PATENT APPLICATION

This application claims the benefit of Korean Patent Application No. 10-2009-0104039, filed on Oct. 30, 2009, in the Korean Intellectual Property Office, the disclosure of which is incorporated herein in its entirety by reference.

### BACKGROUND OF THE INVENTION

1. Field of the Invention

The present invention relates to a stress-reducing type rotor, and more particularly, to a stress-reducing type rotor that is preliminarily rotated so that the rotor is plastic-deformed in advance, and thus less plastic deformation occurs when the rotor rotates at high speed compared to a case when the plastic deformation is not performed in advance.

2. Description of the Related Art

Generally, in order to prevent plastic deformation of a rotor cylinder or rotor cylinder having a hole due to centrifugal force, a common large-sized rotor rotating at high speed employs interference fit between an external circumference of the rotor cylinder and a reinforcing ring formed of a material having a higher resistance to centrifugal force than the material of the rotor cylinder.

FIG. 1 shows a conventional high-speed rotor. FIG. 2 shows interference 3 due to interference fit between a reinforcing ring 2 and a rotor cylinder 1 or a rotor cylinder 4 having a hole. When the rotor cylinder 1 or the rotor cylinder 4 having a hole rotates at a predetermined rotation speed or more, the rotor cylinder 1 or the rotor cylinder 4 having a hole is plastic-deformed. By applying pre-stress on the surface of the external circumference of the rotor cylinder 1 or rotor cylinder 4 having a hole due to the interference fit between the reinforcing ring 2 and the external circumference of the rotor cylinder 1 or rotor cylinder 4 having a hole, less plastic deformation occurs than a case of a rotor cylinder without the reinforcing ring 2, even when the rotor cylinder 1 or the rotor cylinder 4 having a hole is rotating at high speed.

However, during the interference fit between the reinforcing ring 2 and the external circumference of the rotor cylinder 1 or rotor cylinder 4 having a hole, there is a limit in interference to be achieved due to temperature limitations of shrinkage fitting, and thus an effect of reducing stress concentration, which may be achieved by pre-stress generated when the rotor cylinder 1 or the rotor cylinder 4 having a hole rotates at high speed, may be insignificant.

### SUMMARY OF THE INVENTION

The present invention provides a rotor that is rotated preliminarily so that the rotor is plastic-deformed in advance by centrifugal force, and thus interference is increased compared to a case when plastic deformation is not preliminarily performed so that stress concentration generated in a rotor cylinder is reduced by pre-stress.

According to an aspect of the present invention, there is provided a rotor including a rotor cylinder and a reinforcing ring for surrounding the external circumference of the rotor cylinder, wherein the rotor is preliminarily rotated at high speed so that the rotor is plastic-deformed in advance, so that the rotor is not plastic-deformed even when the rotor rotates at high speed after the rotor is plastic-deformed in advance.

According to another aspect of the present invention, there is provided a rotor including a rotor cylinder having a hole formed in the center of the rotor cylinder and a reinforcing ring for surrounding the external circumference of the rotor cylinder, wherein the rotor preliminarily rotates at high speed so that the rotor is plastic-deformed in advance, so that the rotor is not plastic-deformed even when the rotor rotates at high speed after the rotor is plastic-deformed in advance.

### BRIEF DESCRIPTION OF THE DRAWINGS

The above and other features and advantages of the present invention will become more apparent by describing in detail exemplary embodiments thereof with reference to the attached drawings in which:

FIG. 1 shows a conventional a high-speed rotor;

FIG. 2 shows interference due to interference fit between a reinforcing ring and a rotor cylinder or a rotor cylinder having a hole;

FIG. 3 is a perspective view of a rotator having a hole formed in a center thereof, according to an embodiment of the present invention;

FIG. 4 is a perspective view of a rotor having a hole formed therein, according to an embodiment of the present invention; and

FIG. 5 is a perspective view of the case a hole is formed in a conventional rotor and the conventional rotor is plastic-deformed during rotation of the conventional rotor.

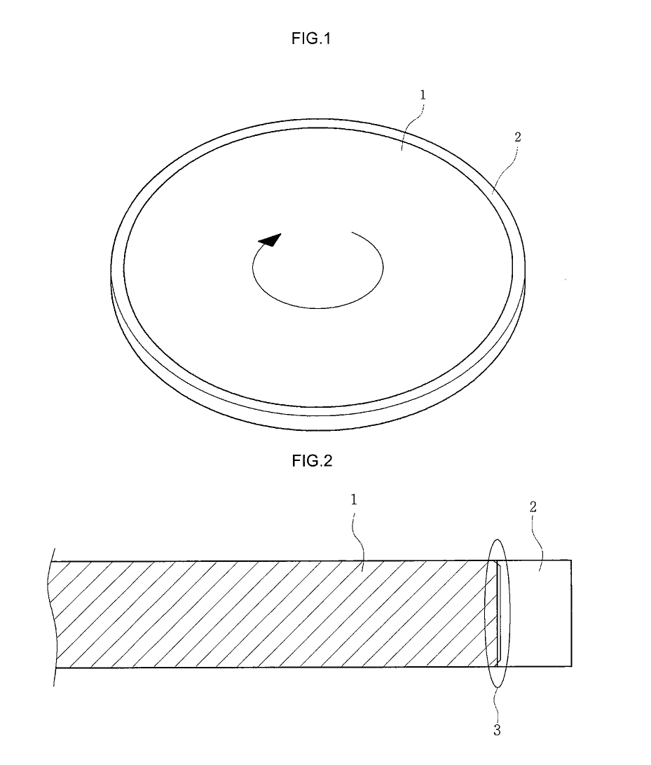

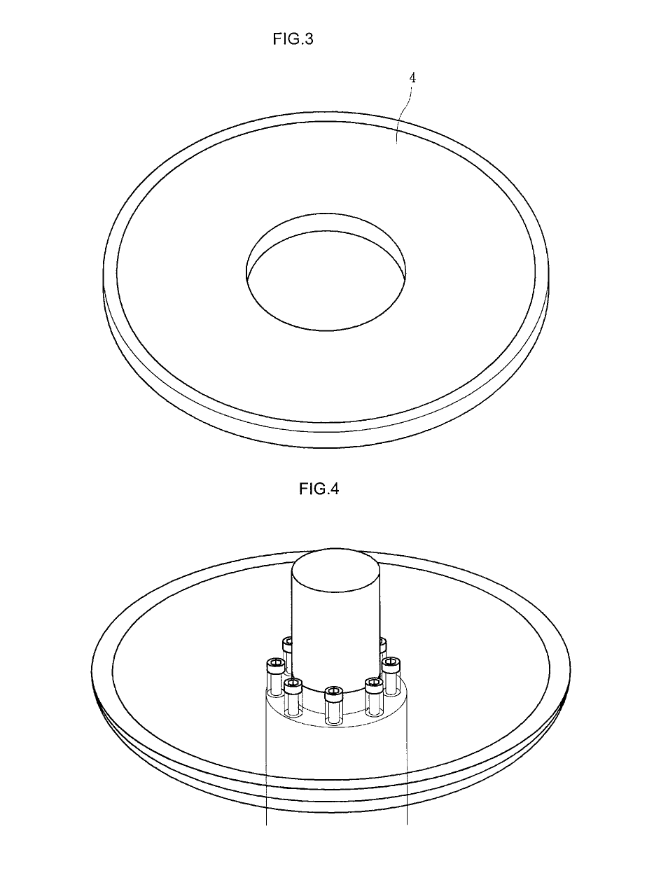

### DETAILED DESCRIPTION OF THE INVENTION

According to an embodiment of the present invention, a rotor is preliminarily rotated so that the rotor is plastic-deformed in advance by centrifugal force, and thus interference is increased compared to a case when plastic deformation is not preliminarily performed so that stress concentration generated in a rotor cylinder is reduced by pre-stress. In addition, a rotor includes a rotor cylinder having a hole formed in the center thereof and a reinforcing ring for surrounding an external circumference of the rotor cylinder, wherein the rotor is not plastic-deformed even when the rotor rotates at high speed. The reinforcing ring is formed of a material having a stronger tolerance with respect to centrifugal force than the material of the rotor cylinder.

The present invention will now be described more fully with reference to the accompanying drawings, in which exemplary embodiments of the invention are shown. The invention may, however, be embodied in many different forms and should not be construed as being limited to the embodiments set forth herein; rather, these embodiments are provided so that this disclosure will be thorough and complete, and will fully convey the concept of the invention to those skilled in the art.

According to embodiments of the present invention, a stress-reducing type rotor includes a rotor cylinder 1 or a rotor cylinder 4 having a hole; and a reinforcing ring 2. In addition, by virtue of interference fit between the reinforcing ring 2 and the external circumference of the rotor cylinder 1 or rotor cylinder 4 having a hole, the rotor cylinder 1 or the rotor cylinder 4 having a hole is preliminarily rotated at high speed, and thus the rotor cylinder 1 or the rotor cylinder 4 having a hole is plastic-deformed in advance by centrifugal force.

FIG. 3 shows a plastic-deformed rotor 4 according to an embodiment of the present invention. In order to configure the plastic-deformed rotor 4, the strength and yield strength of the plastic-deformed rotor 4 may be smaller than those of the reinforcing ring 2.

There are interference limitations in a conventional rotor cylinder using the reinforcing ring 2 due to material properties of the conventional rotor cylinder and the reinforcing ring 2 and other various circumstantial limitations, and thus pre-stress is not sufficiently applied to the conventional rotor cylinder. When the rotator cylinder 4 and the reinforcing ring 2 that are assembled by interference fit rotate at high speed in order to sufficiently achieve interference 3, the rotor cylinder 4 and the reinforcing ring 2 are deformed by centrifugal force. When the rotator cylinder 4 and the reinforcing ring 2 rotate at a rotation speed so as to generate stress that is equal to or greater than the yield strength of the rotor cylinder and equal to or smaller than the yield strength of the reinforcing ring, the deformation of the rotor cylinder exceeds an elastic range of the rotor cylinder so that the rotor cylinder is irreversibly deformed, and the reinforcing ring 2 is likely to return to an original state where the rotor cylinder stops rotating. That is, the external circumference of the rotor cylinder is greater than the case where the rotor cylinder does not rotate at high speed, and the internal circumference of the reinforcing ring is the same as the case where the rotor cylinder does not rotate at high speed. Thus, interference is increased so as to generate a greater pre-stress than the case where the rotor cylinder does not rotate at high speed. In addition, when the plastic-deformed rotor 4 rotates, the plastic deformation of the plastic-deformed rotor 4 is less than the conventional rotor cylinder.

Interference refers to the degree to which the external circumference of the rotor cylinder is greater than the internal circumference of the reinforcing ring, prior to interference fit (shrinkage fitting, etc.). After the interference fit is performed, the surface of the external circumference of the rotor cylinder and the surface of the internal circumference of the reinforcing ring come in contact with each other. In this case, as the interference is increased, a pre-stress between the rotor cylinder and the reinforcing ring is further increased.

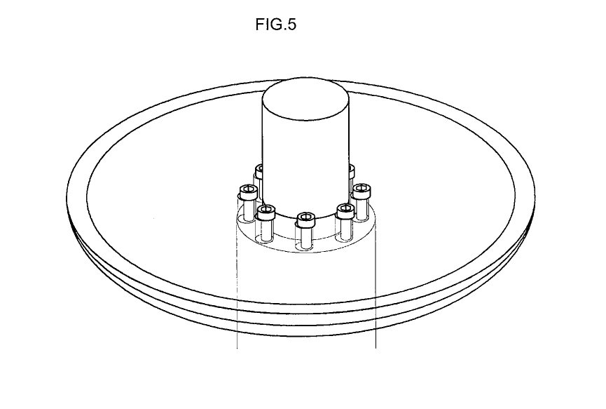

Generally, a conventional rotor includes a hole formed in the center thereof, like in FIG. 3, and is mostly installed on a second rotor that is bigger than the conventional rotor. The conventional rotor is installed on the second rotor by inserting the axis of the second rotor into the hole of the conventional rotor and bolt fixing the assembly. Relative locations between the conventional rotor and the second rotor may be changed to the case of FIG. 5, which may cause sudden unbalance in the second rotor. However, according to embodiments of the present invention, during the preliminary plastic deformation, unbalance may be prevented by a stable structure of FIG. 4.

In a stress-reducing type rotor according to the present invention, interference is sufficiently great by generating plastic deformation of a rotor cylinder in advance. Thus, when the rotor cylinder rotates at high speed, the degree of deformation is small, and thus the change in location and size of the tapped hole is very small so that relative locations of the rotor and a second rotor bigger than the rotor are not changed, thereby preventing unbalance.

According to the present invention, a rotor is preliminarily rotated at high speed, so that a rotor cylinder is previously plastic-deformed. Thus, even when the rotor rotates at high speed, interference is increased compared to the case where plastic deformation is not preliminarily performed, and thus stress concentration generated in the rotor cylinder may be reduced by pre-stress.

What is claimed is:

1. A rotor comprising a rotor cylinder and a reinforcing ring for surrounding the external circumference of the rotor cylinder, wherein the rotor preliminarily rotates at high speed so that the rotor is plastic-deformed in advance, so that the rotor is not plastic-deformed even when the rotor rotates at high speed after the rotor is plastic-deformed in advance.

2. A rotor comprising a rotor cylinder having a hole formed in the center of the rotor cylinder and a reinforcing ring for surrounding the external circumference of the rotor cylinder, wherein the rotor preliminarily rotates at high speed so that the rotor is plastic-deformed in advance, so that the rotor is not plastic-deformed even when the rotor rotates at high speed after the rotor is plastic-deformed in advance.
